(19) United States
(12) Patent Application Publication
(10) Pub. No.: US 2008/0270431 A1
(43) Pub. Date: Oct. 30, 2008

(54) Genealogical System and Method

(76) Inventor: Nancy Garbero, Fenton, MO (US)

Correspondence Address: PATWRITE LLC, 408 W. MAIN ST., MARSHALLTOWN, IA, 50158-5759, US

(21) Appl. No.: 12/110,507

(22) Filed: Apr. 28, 2008

Related U.S. Application Data
(60) Provisional application No. 60/914,315, filed on Apr. 26, 2007.

(51) Int. Cl. G06F 17/30

(52) U.S. Cl. 707/100; 707/E17.005

(57) ABSTRACT

A system and method for creating a genealogical history uses a plurality of graphical keys that help a user to plan, organize and optimize a search and recordation of genealogical documents and sources. There are 3 types of keys which include Family Keys, Historical Keys and Ethnic Keys. These 3 types are divided into 9 document classifications including Primary, Time Segment, Combined Record, Navigational, Personal Family, Community Event, Special Service, Historical and Ethnic Records. The system provides a framework for logically connecting each document with additional information. The system also provides for quality control of the results to provide a selected level of confidence in the resulting family history. The system and method provides a clear and simple framework by which an individual can trace a family history by following predetermined steps leading the user to construct a reliable family history.

### RELATED APPLICATIONS

This application claims priority and herein incorporates by reference U.S. provisional patent application 60/914,315 filed Apr. 26, 2007.

### BACKGROUND OF THE INVENTION

As generations pass, it is important to maintain our link with the past. Many people today have a renewed interest in finding an accurate family history for many reasons such as medical screening and diagnosis, religious reasons or just curiosity.

It is often a long and arduous process to recreate a family tree that goes back more than a few generations and is often intimidating and confusing. Most serious individuals turn to a professional genealogist at some point in their search. The process of tracing family histories is an extremely time intensive process.

Adding to this complexity is the fact that even one error in a source document can ripple through the history to the point where it is completely unreliable. Often, it appears so difficult and haphazard, that many people give up after attempting to trace their family history. There is a need for a method and system that allows an individual to trace their family history reliably and systematically.

### SUMMARY OF THE INVENTION

A system and method for creating a genealogical history uses a plurality of graphical keys that help a user to plan, organize and optimize a search and recordation of genealogical documents and sources. There are 3 types of keys which include Family Keys, Historical Keys and Ethnic Keys. These 3 types are divided into 9 document classifications including Primary, Time Segment, Combined Record, Navigational, Personal Family, Community Event, Special Service, Historical and Ethnic Records. The system provides a framework for logically connecting each document with additional information. The system also provides for quality control of the results to provide a selected level of confidence in the resulting family history. The system and method provides a clear and simple framework by which an individual can trace a family history by following predetermined steps leading the user to construct a reliable family history.

Other features and advantages of the instant invention will become apparent from the following description of the invention which refers to the accompanying drawings.

### BRIEF DESCRIPTION OF THE DRAWINGS

FIG. 1 is an organizational chart showing the three Key Types according to an embodiment of the present invention.

FIG. 2 is a chart illustrating typical Family Keys according to an embodiment of the present invention.

FIG. 3 is a chart showing typical Historical Keys according to an embodiment of the present invention.

FIG. 4 is a chart showing typical Ethnic Keys according to an embodiment of the present invention.

FIG. 5 is a chart showing typical Primary Keys according to an embodiment of the present invention.

FIG. 6 is chart showing typical Time Segment Keys according to an embodiment of the present invention.

FIG. 7 is chart showing typical Combined Record Keys according to an embodiment of the present invention.

FIG. 8 is chart showing typical Navigational Keys according to an embodiment of the present invention.

FIG. 9 is chart showing typical Personal Family Keys according to an embodiment of the present invention.

FIG. 10 is chart showing typical Community Event Keys according to an embodiment of the present invention.

FIG. 11 is chart showing typical Special Service Keys according to an embodiment of the present invention.

FIG. 12 is chart showing typical Historical Record Keys according to an embodiment of the present invention.

FIG. 13 is chart showing typical Ethnic Record Keys according to an embodiment of the present invention.

FIG. 14 is an illustration of a Quality Control Tag according to an embodiment of the present invention.

FIG. 15 is an illustration of a front of a graphical key according to an embodiment of the present invention.

FIG. 16 is an illustration of a back of a graphical key according to an embodiment of the present invention.

FIG. 17 is an illustration showing a plurality of graphical keys according to an embodiment of the present invention.

FIG. 18 is a system diagram according to an embodiment of the present invention.

FIG. 19 is an illustration showing a plurality of graphical keys according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

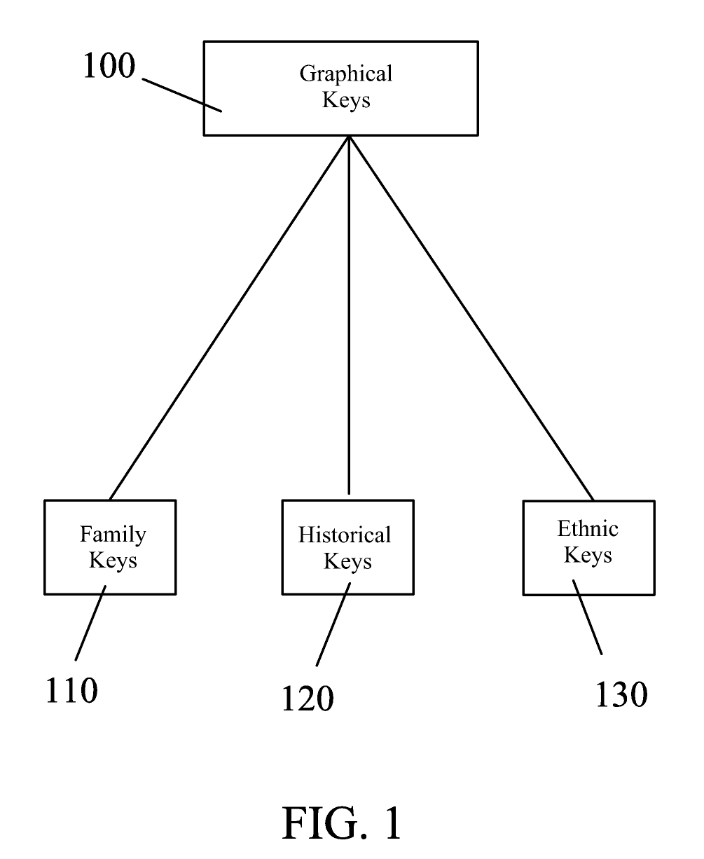

Referring to FIG. 1, a system and method for creating a genealogical history utilizes a set of graphical keys 100 that allow a user to plan, organize and generally guide the user through all aspects of tracing the history. There are 3 types of Keys 100 including Family Keys 110, Historical Keys 120 and Ethnic Keys 130. These broad types start the process of directing a user and focusing them on the important steps, sources and types of materials required in historical research.

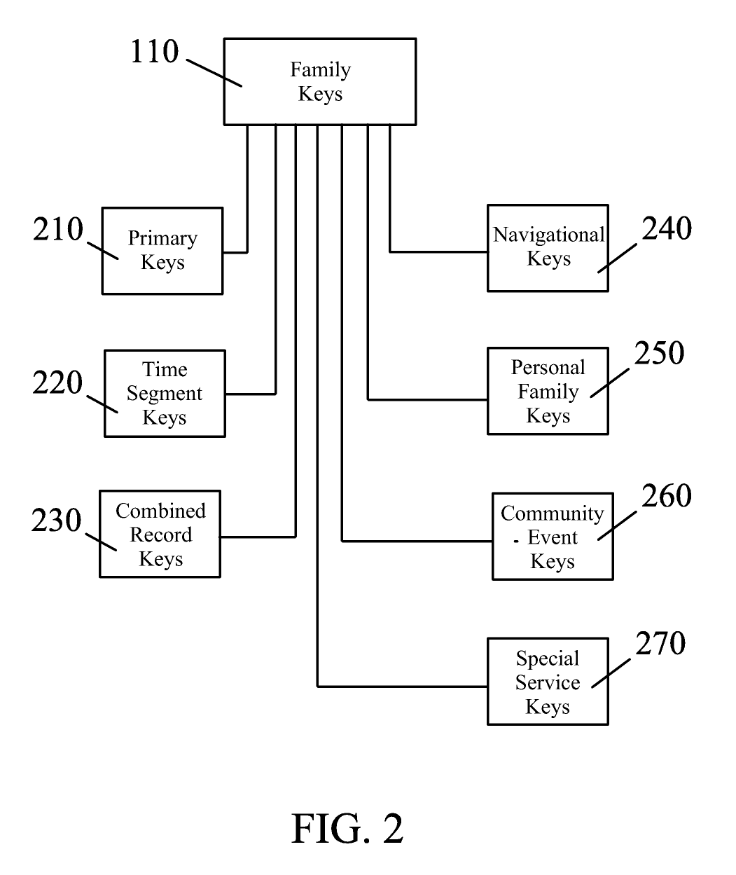

FIG. 2 further breaks down the Family Key 110 into 7 sub-keys. Family Keys 110 includes Primary Keys 210, Time segment Keys 220, Combined Record Keys 230, Navigational Keys 240, Personal Family Keys 250, Community Event Keys 260 and Special Service Keys 270. Of course additional sub-keys are possible and these sub-keys are very useful in conducting a thorough genealogical history.

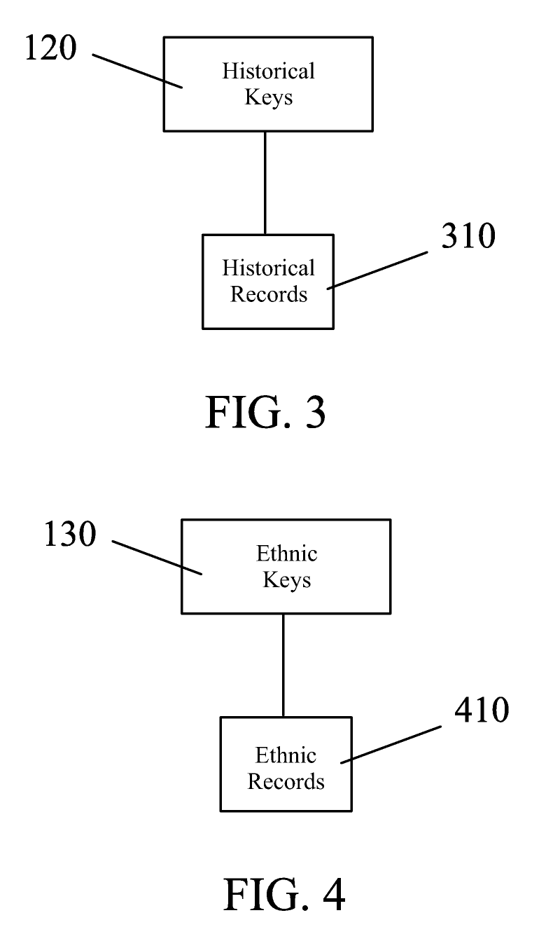

FIGS. 3 and 4 illustrate a further breakdown of Historical Keys 120 into an Historical Records 310 sub-key and Ethnic Keys 130 into an Ethnic Records 410 sub-key. Each of these sub-keys will be described in more detail below.

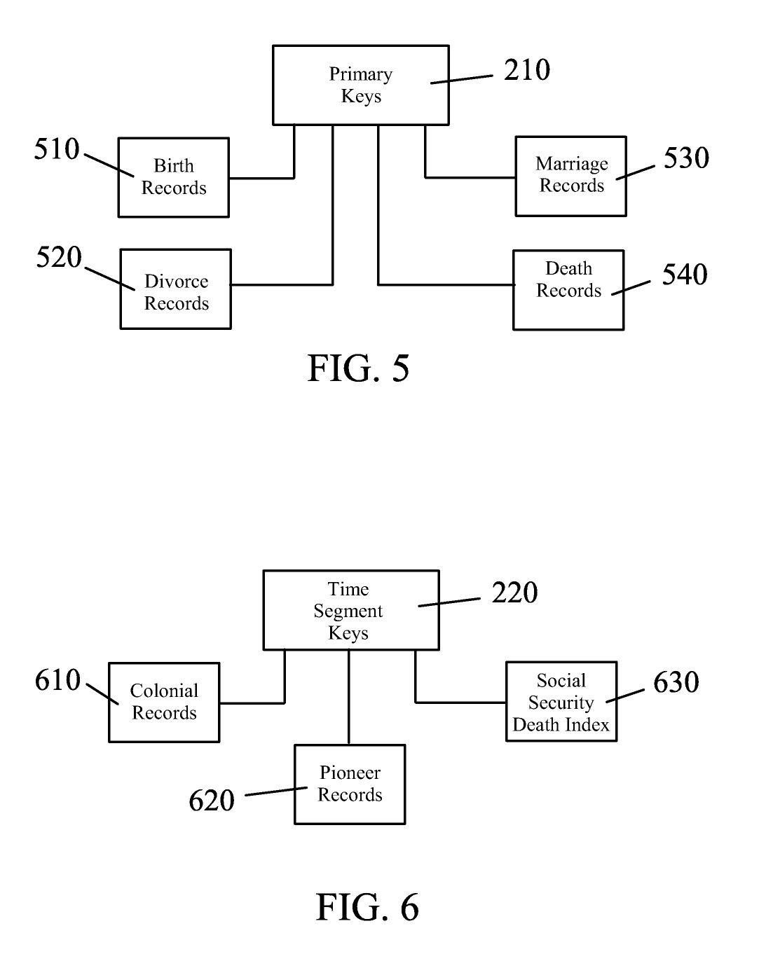

Referring now to FIGS. 5 and 6, Primary Keys 210 include Birth Records 510, Divorce Records 520, Marriage Records 530 and Death Records 540. Time Segment Keys 220 include such things as Colonial Records 610, Pioneer Records 620 and Social Security Death Index (SSDI) 630. In world-wide applications, other countries may refer to these kind of documents by different names, but the type of material is generally the same and should be understood that Primary Keys 210 would include titles appropriate to the country of interest.

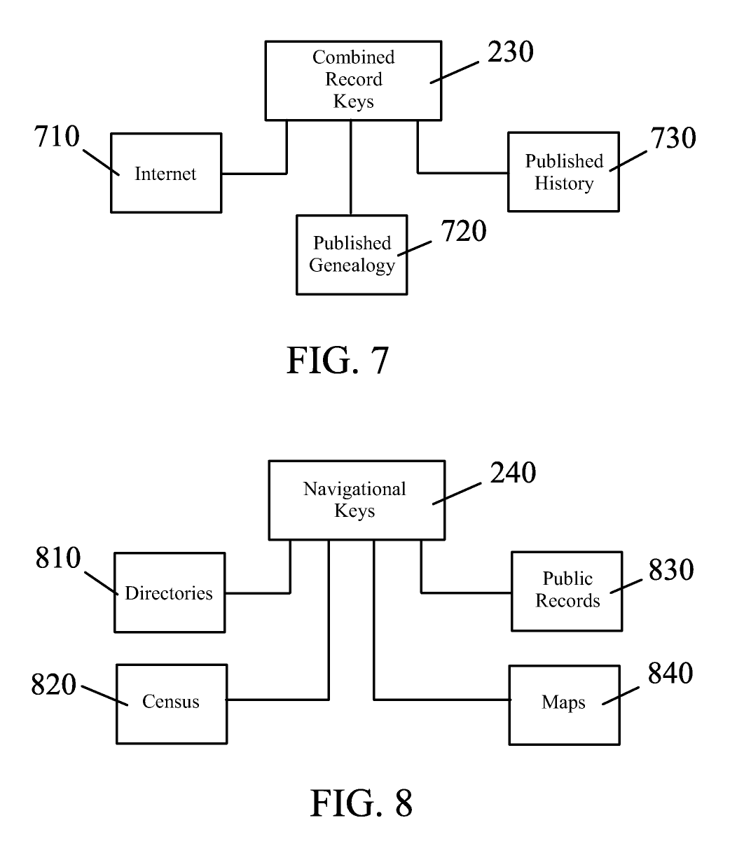

With reference to FIGS. 7-8 and 18, Combined Record Keys 230 includes things like the Internet 710, Published Genealogies 720 and other Published Histories 730. Navigational Keys 240 reference things like Directories 810, Census Data and Publications 820, Public Records 830 and Maps 840. If the system is implemented using a computer 1860, keys like Maps 840 may be located on a database 1820 and 1830 accessible through a network 1810 an in electronic communication 1840 with computer or other network appliance such as a PDA, Internet enabled cell phone, etc. Also, if data like a map is accessed as a hyperlinked document, a user may be able to successively click to target a specific geographic area of interest, public databases etc. making the system extremely user friendly. It should be noted; however, that it is not necessary to be connected to any kind of network to practice the instant invention.

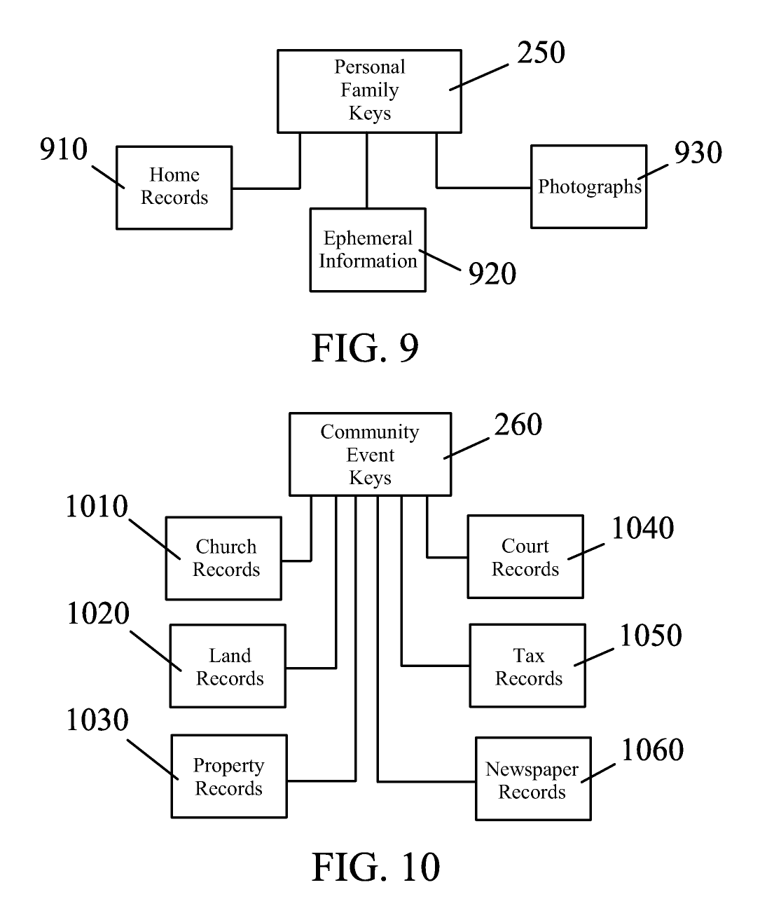

Referring to FIG. 9 and 10, Personal Family Keys 250 include Home Records 910, Ephemeral Information 920 that although not created with permanence in mind, has none the less survived and Photographs 930. Community Event Keys 260 include things like Church Records 1010, Land Records 1020, Property Records 1030, Court Records 1040, Tax Records 1050 and Newspaper Records 1060.

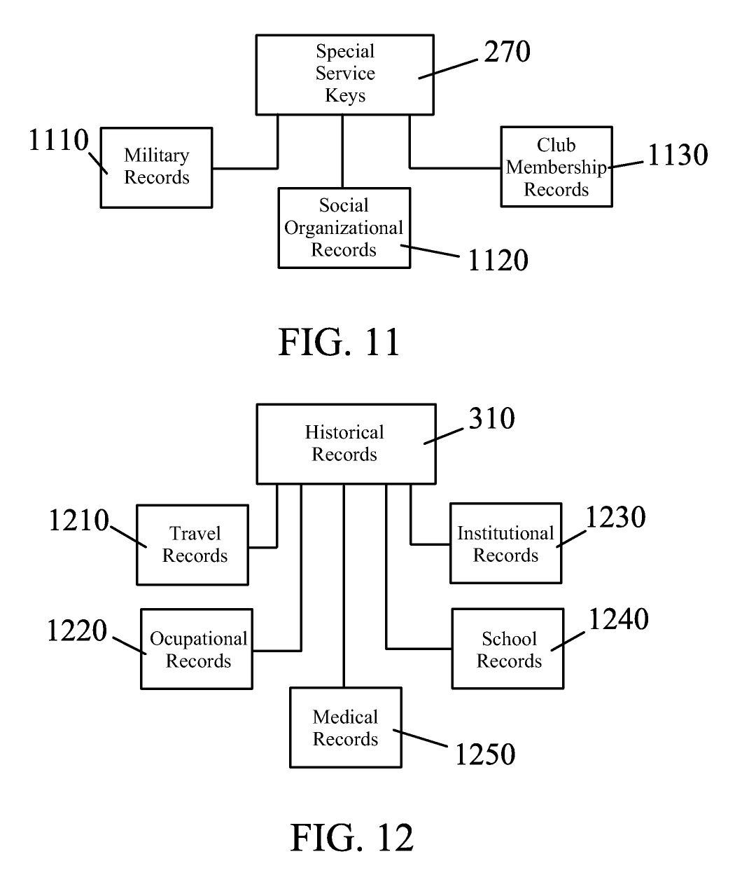

With reference to FIGS. 11 and 12, Special Service Keys 270 includes Military Records 1110, Social Organizational Records 1120 and Club Membership Records 1130. Historical Records 310 includes Travel Records 1210, Occupational Records 1220, Institutional Records 1230, School Records 1240 and Medical Records 1250.

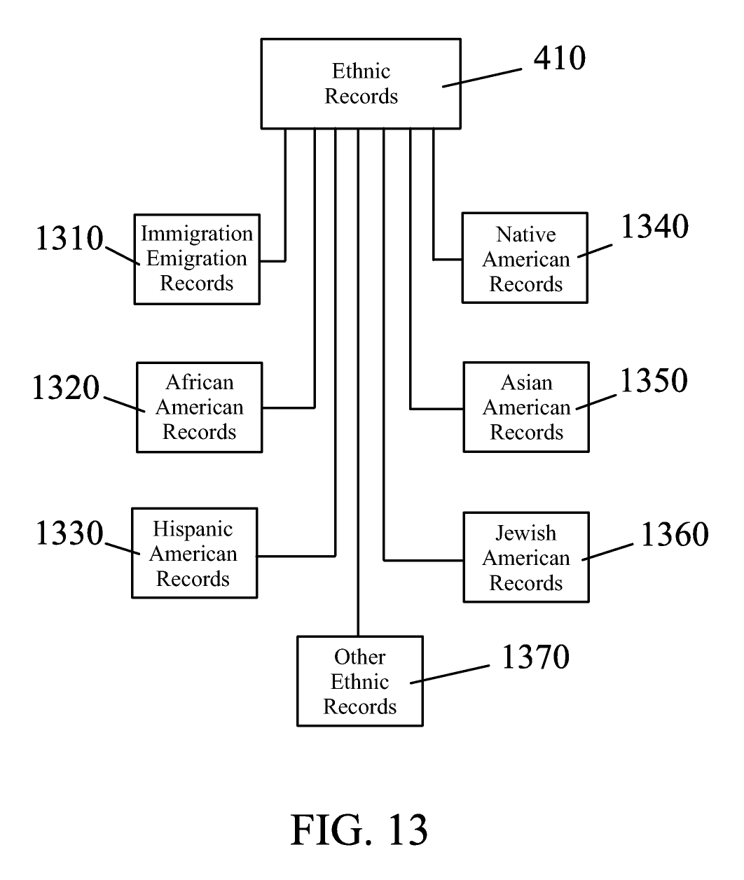

Referring to FIG. 13, Ethnic Records 410 includes Immigration/Emigration Records 1310, African American Records 1320, Hispanic American Records 1330, Native American Records 1340, Asian American Records 1350, Jewish American Records 1360 and Other Ethnic Records 1370. Other Ethnic Records 1370 include such records found anywhere in the world.

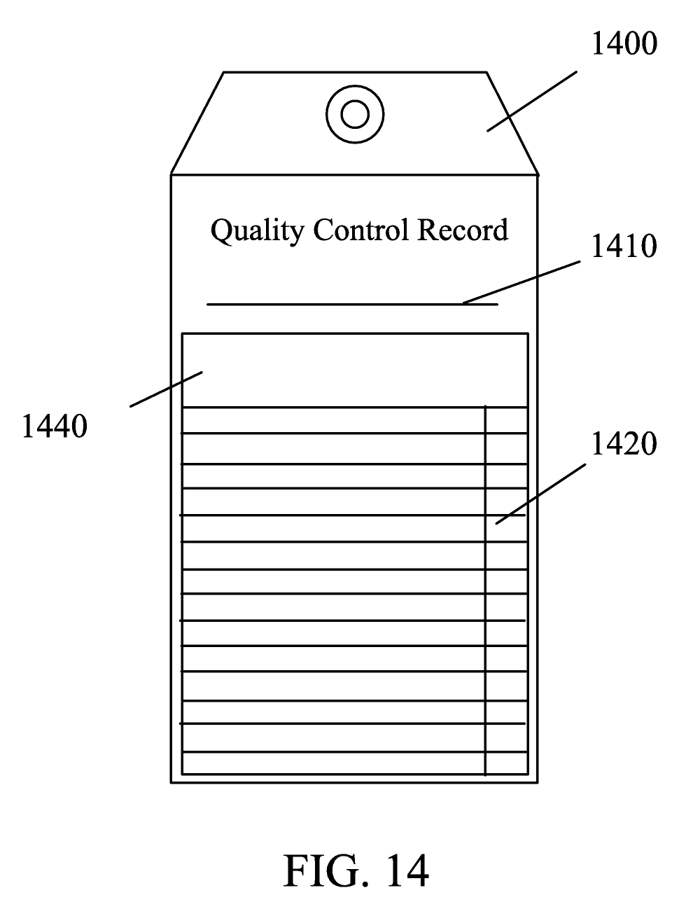

FIG. 14 shows a Quality Control Record 1400 according to an embodiment that allows a user to track and control the quality of the information reviewed using a coding system that includes coding to allow the user or others to judge the status and/or quality of the data. As an example, a coding system may be placed on Record 1400 at the location shown by 1440. An example of a Quality Control code system includes (Y)es, (N)ot (A)pplicable, (D)oesn't (E)xist, (M)issing; (Fi)re; (Fl)ood; (W)ar, (V)andal. Of course other labels and codes may be used to allow the user to keep track of and control the quality of the data examined. In this way, the present invention uses cross-referencing to provide a self-error checking system to automatically tag any information that might be in error when the user follows the instant invention. Additionally, an informational section 1420 helps the user select the type of data needed to complete the genealogical research and include a listing of at least some of the Graphic Keys discussed above. A name or other information is placed on line 1410 to aid the user in keeping track of who the Key 1400 belongs to.

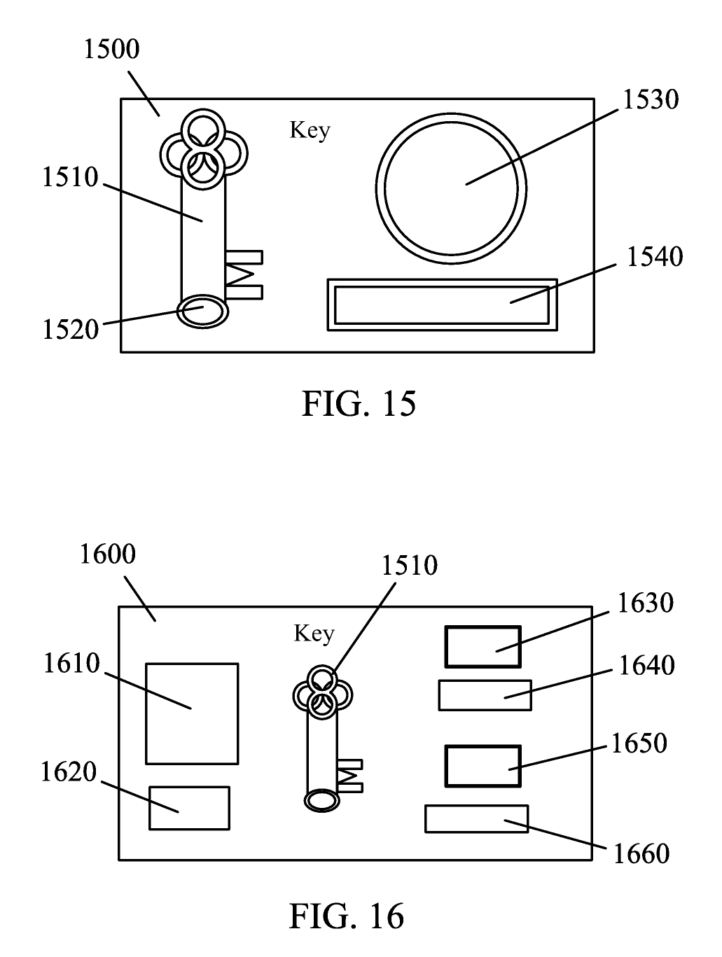

Now referring to FIGS. 15 and 16, a typical Graphical Key 1500 is shown having a large icon 1530 which graphically represents a particular type of data. A graphic of a key 1510 includes a small graphic 1520 which is a smaller version of the graphic 1530 shown on the front of Key 1500. A text area 1540 includes a brief description of the Key 1500. The back of Key 1600 is shown with additional graphics 1630 and 1650 and additional text sections 1610, 1620, 1640 and 1660. Also, Keys 1500, 1600 may be single sided and in such an embodiment, Keys 1500, 1600 represent different formats, rather than front and backs. Of course, Key 1500 shown is a typical application, however, it should be clear to one skilled in the art that the exact location of the text and graphic is adjustable to suit the specific type of information being displayed. Text section 1620 may also includes a user fillable area allowing the user to fill in the appropriate information depending on the specific Key being used. For example, Key 1600 may be an Obituary Key with a graphic of the deceased person 1610 and the pertinent information filled in by the user in test section 1620 such as name, date of birth, place of birth, etc. Graphic key 1510 is the element that ties each application together and allows a user to identify the kind of data being discussed by simply viewing graphic key 1510. Research aids, suggestions on how to locate records and quality control information may be placed on Keys 1500. A separate key 1510 may be provided for each type and sub-type as discussed above. Graphics can include things like a scanned copy of a newspaper containing the data, a picture of a library where the data is located, a picture of a family member whose data is reproduced, etc. in order to give the user a quick visual reference of the information contained therein. Additionally, a user following the instant invention, is keeping track of any missing items and this Inventory of Missing Items may be kept on its own Key, ensuring quality control during the process. The inventory key is used to keep track of what is missing as well as why it is missing; fire, damaged document, etc. An inventory of the items obtained is also kept by a user following the instant invention and this inventory includes where the original data is located, it's condition, etc. that is used to ensure quality control throughout the process.

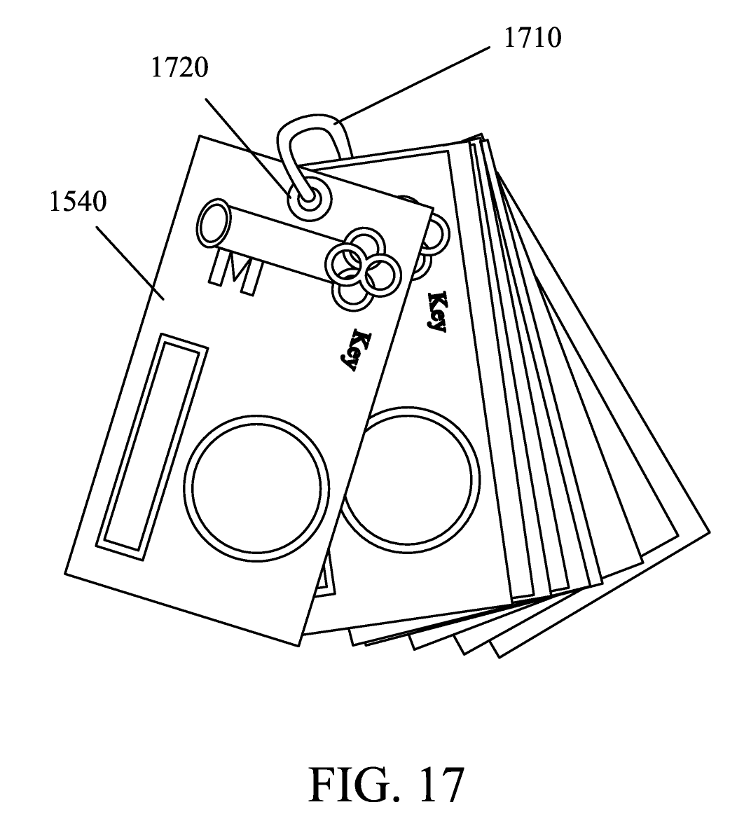

Referring now to FIG. 17, a convenient take along Key set 1540 is provided with a binder portion 1720 and a binder clip 1710 to allow easy transport allowing a user to take the Keys 1540 to a library, office building, etc. Of course rather than printed Keys, Keys 1540 may be displayed on a computer, PDA or other electronic device that would function as an electronic version according to the instant invention. Other items such as Key Holders (not shown), board games (not shown), software programs, etc could be provided to allow a user to have a complete genealogical experience while using the instant invention.

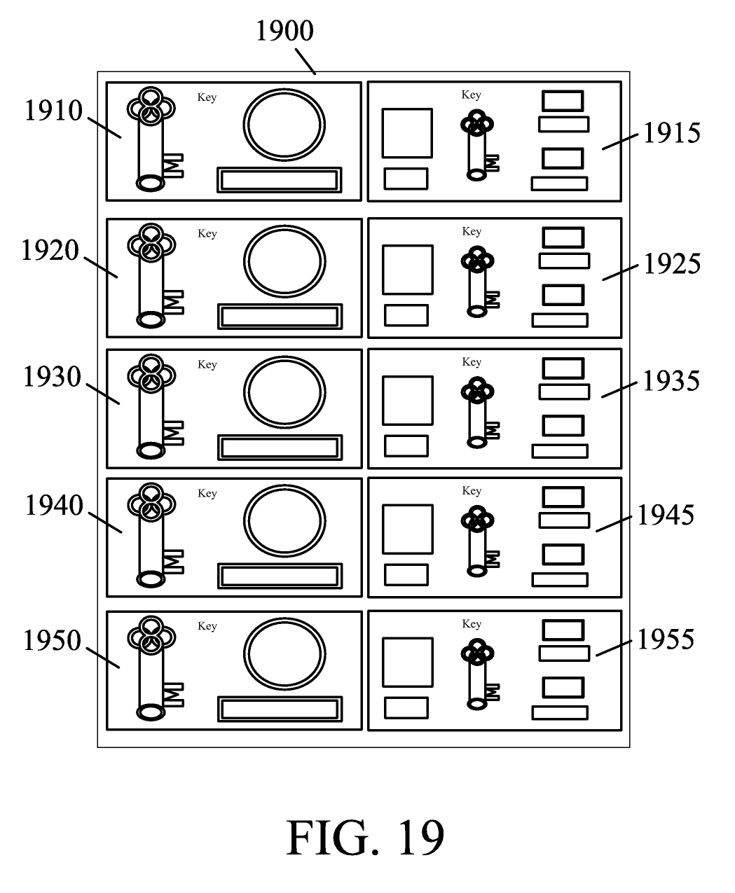

Referring now to FIG. 19, a convenient take along Key set page 1900 is provided displaying a plurality of Keys 1910, 1915, 1920, 1925, 1930, 1935, 1940, 1945, 1950 and 1955. Of course the size and number of Keys may vary according to specific applications and or user preferences. Additionally, individual pages 1900 may be placed in a binder (not shown) for convenient organization and portability. Also, as discussed above, rather than printed Key page, Key pages 1900 may be electrically displayed on a computer, PDA or other electronic device that would function as an electronic version according to the instant invention.

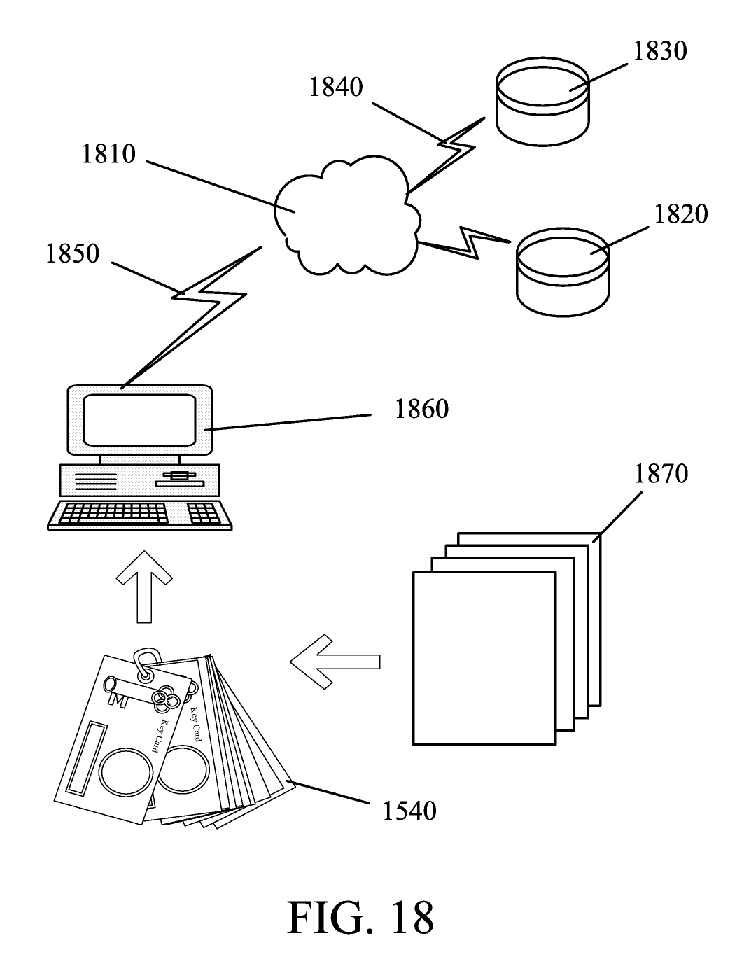

Referring to FIG. 18 again, original data and documents 1870 are examined with reference to Keys 1540 and may be entered into computer 1860 or physically organized in the non-electronic embodiment. An appropriate software program such as a database, spreadsheet or a proprietary program is loaded or resident on computer 1860 and is used to store and organize the date. As discussed previously, if computer 1860 is connected to a network 1810 through a LAN, Broadband, Dial-up, Wi-Fi, Hot Spot or other technology allowing network access, online databases 1830 and 1820 may be accessed remotely rather than physically examining the data.

The system and method for creating a genealogical history according to an embodiment of the present invention allows the user to focus and gather relevant information that would likely be missed if a user were to simply run a name search.

Each State in the United States has its own unique dates of origination recorded in its records. States are divided into counties, townships, parishes, unincorporated cities, etc. and often have their own unique dates of origination of its records. Each township has its own unique dates of origination of its records. These are inventoried and categorized by time frames and made available to the public. Also, the present invention is applicable for world-wide use where countries are divided into unique territories which have specific titles such as Shires in Great Britain or union territories in India, etc. The user simply fills in the appropriate title in spaces.

The method according to the present invention includes classifying and grouping key documents into categories using graphic symbols that illustrate key categories thus categorizing all records. Each primary document can reveal other information that is in turn fed back into the present invention to yield even more information. As an example, birth certificates yield the following:

Connectability & Background:

Name of the person born:

Date of the birthday

Place of the person born

The name of the hospital or home of birth

Name of his/her Mother

Name of his/her Father

Mother's birth US state or Country

Father's birth US state or Country

Sometimes the time of the birth

Sometimes the address of the residence of family

Sometimes the occupation of Mother

Sometimes the occupation of Father

Sometimes the number of children born already to the Mother

Another example is a marriage license:

Connectability & Background

Place of Marriage

Name of the Bride

Name of the Groom

Resident of the Bride

Resident of the Groom

Age of Bride

Age of Groom

Spinster, Divorced or Widowed

Marriage Application

Sometimes the Bride's Parent's names, including mother's maiden name

Sometimes the Groom's Parent's names, including mother's maiden name

Sometimes the Bride's place of birth

Sometimes the Groom's place of birth

Occupation of Bride

Occupation of Groom

Quality Control is a very important aspect of the present invention. Reliable family information is very important in many ways. Quality Control for the Record Collection of Individuals in Family Groups

Inventory according to the present invention includes at least a 3 step process.

1. Inventory the records collected on family members

2. Have a place to scan each document

3. Have an inventory for the missing document(s)

Quality Control for Analysis of choosing which documents have errors

Quality Control is not just the number of documents that can be collected on a person. In one embodiment, it is a 4 step process.

Collecting Family and Historical document keys. Add Ethnic key(s) when needed.

Analyze and group each key document to its function properties (connectability or background).

Compare and see if there are any conflicts of information within the collection of documents.

Last, make sure you have collected similar documents for all siblings of the family groups to again compare for any conflicting information or any connectability.

1. Images of Primary Documents that would be on FamilySearch.org, only for patrons to view and download with a Pass code that was registered from filling out the information from their Temple recommend and Membership Number.

2. Quality Control additional software ad-in for TempleReady or other appropriate software: Enter name and date of ancestor. Templeready as usual will match names and dates. For Example: If the Templework has been completed, the image will be frozen and there cannot be an allowance for duplication of the Templework. The Templework has already been completed and is considered a closed record. The work for this person is completed when there is a scanned image of the document that relates to this event.

According to the present invention, even if the Templework is closed, the method would reveal the dates while allowing you to contest a particular item. There is an entry in the program providing that a scanned birth certificate, death certificate, baptism, marriage certificate, etc could be accessed and only viewed if you type a family code to see this document and be able to download this image into your records.

Another issue that is important to the present invention is the medical need to accurately trace family genetic conditions.

In addition to the standard genealogical Keys discussed above, other Keys include specialized themes such as Holiday Themes, Christmas themes, Easter themes, Treasure map and time wheel, Valentines and Halloween, etc. that would be fun and interesting and encourage young users to trace family genealogy. Some other specialized themes could include “How to” Keys for the amateur genealogist, Thanksgiving cornucopia—Native American Genealogy and Mayflower Pilgrims, War Keys: for Revolutionary War, Civil War, Confederate and Union Genealogy, 1812, Mexican War, Vietnam, Korean, WWI, WWII, Spanish American, African American, All Countries, All Wars, All Timelines.

Although the instant invention has been described in relation to particular embodiments thereof, many other variations and modifications and other uses will become apparent to those skilled in the art.

What is claimed is:

1. A system for creating a genealogical history using graphical keys, the system comprising:
a plurality of graphical keys for systematically collecting, classifying and organizing data associated with a genealogical history;
means for accepting, storing, processing and outputting said data;
means for inventorying said data; and
means for establishing quality control over said data.

2. The system according to claim 1 wherein means for accepting, storing, processing and outputting data is a computer and a computer program running on said computer.

3. The system according to claim 1 wherein means for inventorying data is a user fillable form disposed at least a portion of said graphical keys.

4. The system according to claim 1 wherein means for establishing quality control over said data comprises an appropriate standard printed on a portion of said graphical keys.

5. The system according to claim 1 wherein said plurality of graphical keys includes at least one of a family, historical and ethnic key.

6. The system according to claim 5 wherein said family key includes at least one of a primary, time segment, combined record, navigational, personal family, community event, and special service key.

7. The system according to claim 6 wherein said primary key includes at least one of a birth, marriage, divorce and death key.

8. The system according to claim 6 wherein said time segment key includes at least one of a colonial, pioneer and social security death index.

9. The system according to claim 6 wherein said navigational key includes at least one of a directory, public record, census and map.

10. The system according to claim 6 wherein said personal family key includes at least one of a home record, ephemera and photograph.

11. The system according to claim 6 wherein said community event key includes at least one of a church record, court record, land record, tax and property record and newspaper article.

12. The system according to claim 6 wherein said special service key includes at least one of a military record, social organizational and club membership record.

13. The system according to claim 5 wherein said historical key includes at least one of a travel record, occupational record, institutional record, school record and medical record.

14. The system according to claim 5 wherein said ethnic key includes at least one of an ethnic record, ancestral record, immigration/emigration record, Native American record, African American record, Asian American record, Hispanic American record and Jewish American record.

15. A system for creating a genealogical history using graphical keys, the system comprising a plurality of graphical keys for organizing genealogical data according to a classification system; means for inputting said data; means for storing said data; means for processing said data; means for outputting said data; means for preserving said data; and means for authenticating said data.

16. The system according to claim 15 wherein said means for inputting said data is a keyboard in communication with a computer.

17. The system according to claim 15 wherein said means for storing said data is an electronic storage device.

18. The system according to claim 15 wherein said means for storing said data is a user fillable form disposed on at least a portion of said graphical key.

19. The system according to claim 15 wherein said means for processing said data is a computer.

20. A method for using a system to create a genealogical history comprising the steps,
obtaining a plurality of graphical keys;
collecting genealogical data;
organizing said genealogical data according to said graphical keys;
obtaining additional genealogical data as recommended by said graphical keys;
saving a record of genealogical data obtained; and
proofing said genealogical data.
